(19) United States
(12) Patent Application Publication
(10) Pub. No.: US 2017/0228837 A1
(43) Pub. Date: Aug. 10, 2017

(54) Digital Airport Shopping System

(71) Applicant: Hope M. Porter, Lanham, MD (US)

(72) Inventor: Hope M. Porter, Lanham, MD (US)

(21) Appl. No.: 15/428,142

(22) Filed: Feb. 8, 2017

Related U.S. Application Data
(60) Provisional application No. 62/292,796, filed on Feb. 8, 2016.

(51) Int. Cl. G06Q 50/14; G06Q 10/02; G06Q 30/06

(52) U.S. Cl. CPC G06Q 50/14; G06Q 30/0601; G06Q 10/02

(57) ABSTRACT

This software application is designed to provide a platform for offering concierge travel services to the airport traveler as implemented on a smart phone, tablet or computer. The combination of a highly functioning mobile application, first class concierge service and new airline service offerings such as food and retail delivery services, valet parking and valet rental car return and line position reservation services will prove to be impactful in the travel space. The airline traveler will be appreciative of a concierge service that is attentive to detail and understands their needs.

### CLAIM OF PRIORITY

This application claims priority to Provisional Patent Application No. 62/292,796 filed on Feb. 8, 2016, titled “Digital Airport Shopping System” which is incorporated by reference in its entirety.

### BACKGROUND OF THE INVENTION

Field of the Invention

This invention provides a delivery service, and more particularly, to delivery service of food or purchase items for people with limited time to shop.

Related Art

Modern airports can have a wide range of vendors that sell a variety of different products to airport travelers passing through the terminals and surrounding areas of the airport. Examples of such vendors include restaurants, retail stores such as high end boutiques, duty free stores and goods retailers who are selling merchandise that is manufactured locally. However, airport travelers must restrict their activities according to the time of arrival/departure which can impede their ability to purchase items at airport vendors. For example, the traveler may be in a rush to catch a flight and may not have time to stand in line at a carry-out restaurant. Or the traveler may not be familiar with the layout of the airport and is not aware of the full range of vendors and products that are available.

Several factors impact the purchasing ability of the airport traveler, these factors include (1) limited time to purchase, (2) lack of knowledge of site of vendors in relation to the arriving/departing passenger, (3) changing arrival and departure time of flights and (4) changing gate assignments. The elimination of food being offered on domestic flights by most airline carriers, the need of passengers to purchase food for short and long flights has exploded. While the need to purchase food for travel has increased in recent years, the factors impacting a travelers' ability to purchase food in a timely manner have increased.

The reduction in flight seats due to the consolidation of airlines have led to flights being at full capacity. This has led to an increase in the number of travelers utilizing airline and airport services. Additionally, the amount of time needed to manage the flow of the necessary airport services such as reservations and airline services, baggage checks, TSA security clearance and altering flight arrival and departure times have increased the need for services to assist the traveler in connecting with airport vendors.

Digitally connecting independent contractors to provide delivery of food and retail purchases and perform concierge services will assist travelers in navigating the flow of the necessary airport services while ultimately improving their traveling experience. Based on demographics which will be demonstrated later, there is a need for such concierge services to the airport traveler. With our sophisticated mobile application linking vendors/restaurateurs, concierge services and delivery personnel to the airline traveler while offering these services and comparable rates of other concierge services and offering pay for delivery personnel that meets and exceeds the industry for this labor force.

Thus, a need exists for a software application that can be downloaded on a mobile user's smart phone, tablet or computer that can facilitate the purchase and delivery of products that are sold by airport vendors that can facilitate the software application's users so that they can find services and products at a desired location and minimize wait time or wasted time searching out the services or products because the user is in an unfamiliar location.

### SUMMARY

This software application is designed to provide a platform for offering concierge travel services to the airport traveler as implemented on a smart phone, tablet or computer. The combination of a highly functioning mobile application, first class concierge service and new airline service offerings such as food and retail delivery services, valet parking and valet rental car return and line position reservation services will prove to be impactful in the travel space. The airline traveler will be appreciative of a concierge service that is attentive to detail and understands their needs.

Other systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DETAILED DESCRIPTION OF THE DRAWINGS

The components in the figures are not necessarily to scale, emphasis being placed instead upon illustrating the principles of the invention. In the figures, like reference numerals designate corresponding parts throughout the different views.

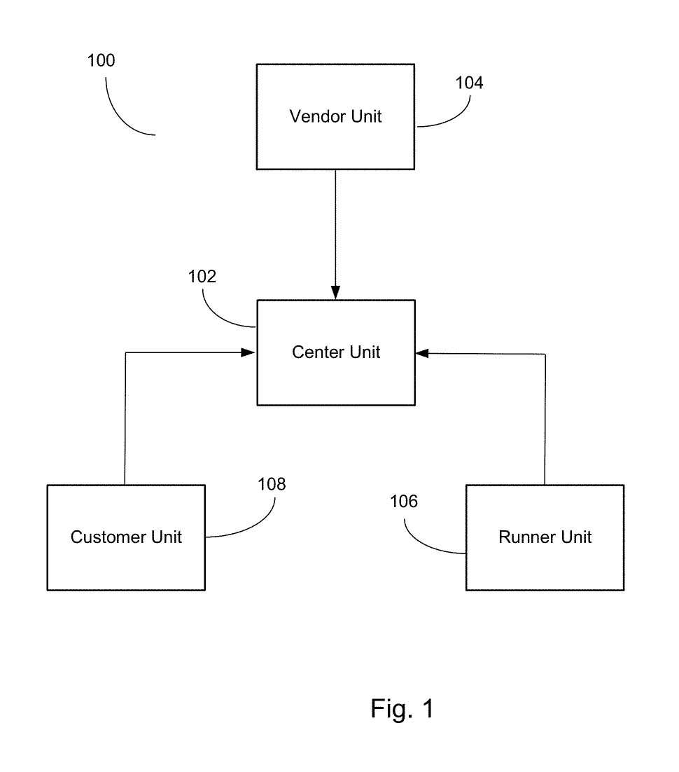

FIG. 1 is a block diagram for the various units in the payment system.

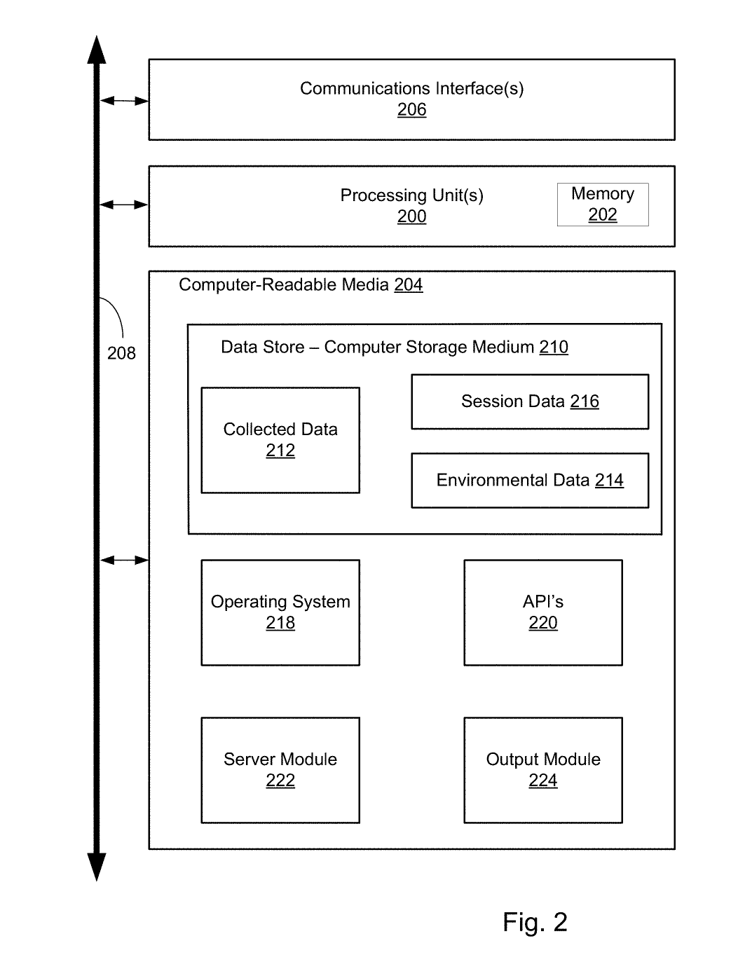

FIG. 2 is a block diagram illustrating an example of an implementation of the methodology of the ordering system implemented in software on computer hardware.

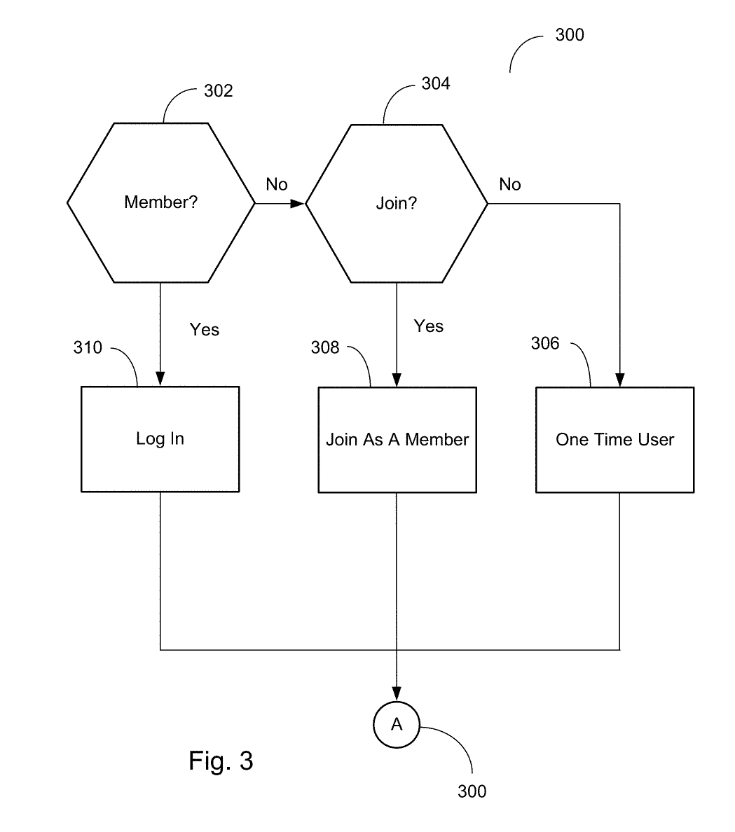

FIG. 3 is a flow chart illustrating the methodology for payment process and ordering of products and services.

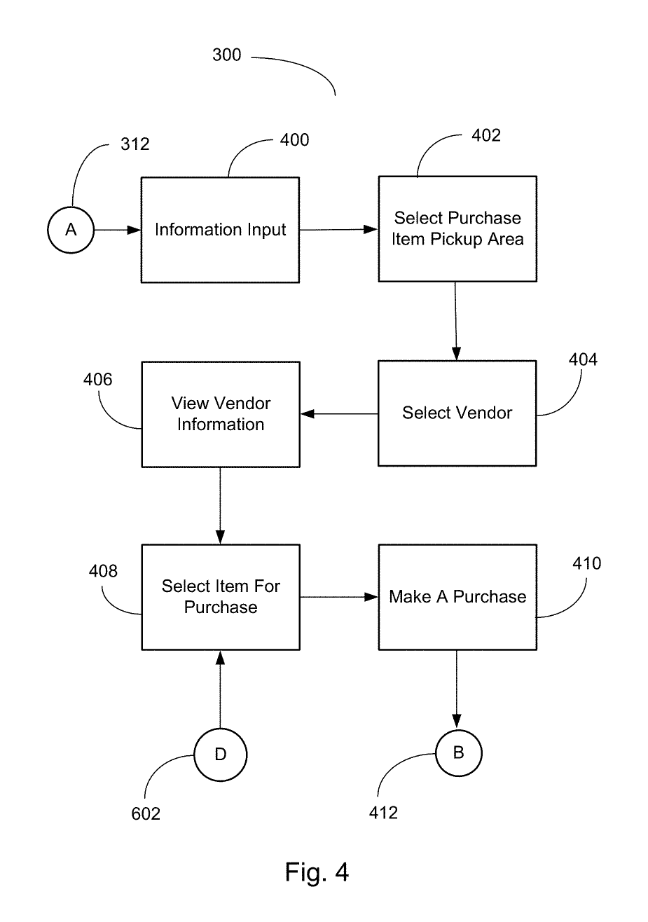

FIG. 4 is a flow chart illustrating the methodology for payment process and ordering of products and services.

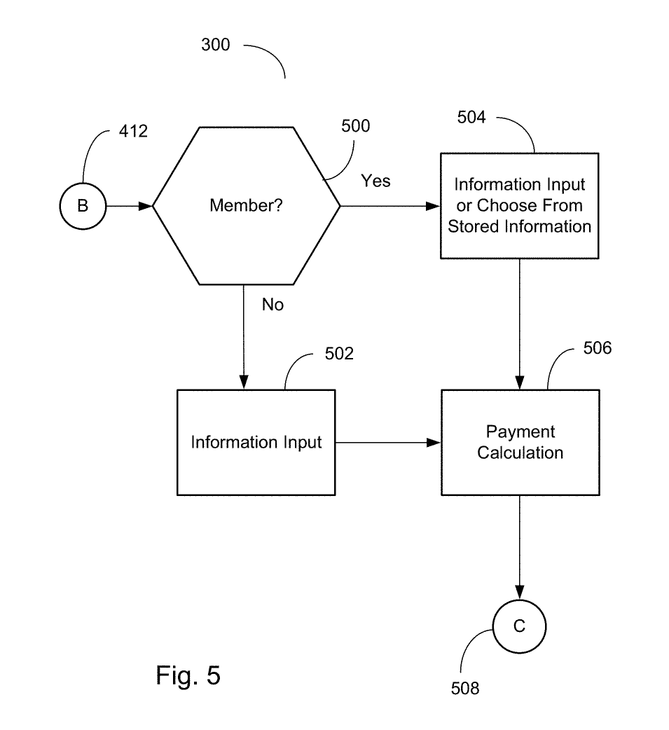

FIG. 5 is a flow chart illustrating the methodology for payment process and ordering of products and services.

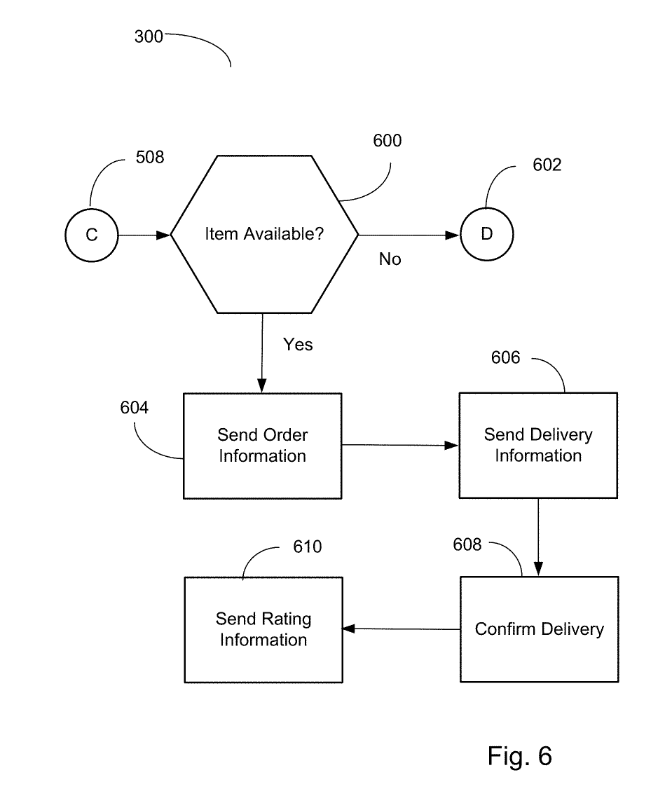

FIG. 6 is a flow chart illustrating the methodology for payment process and ordering of products and services.

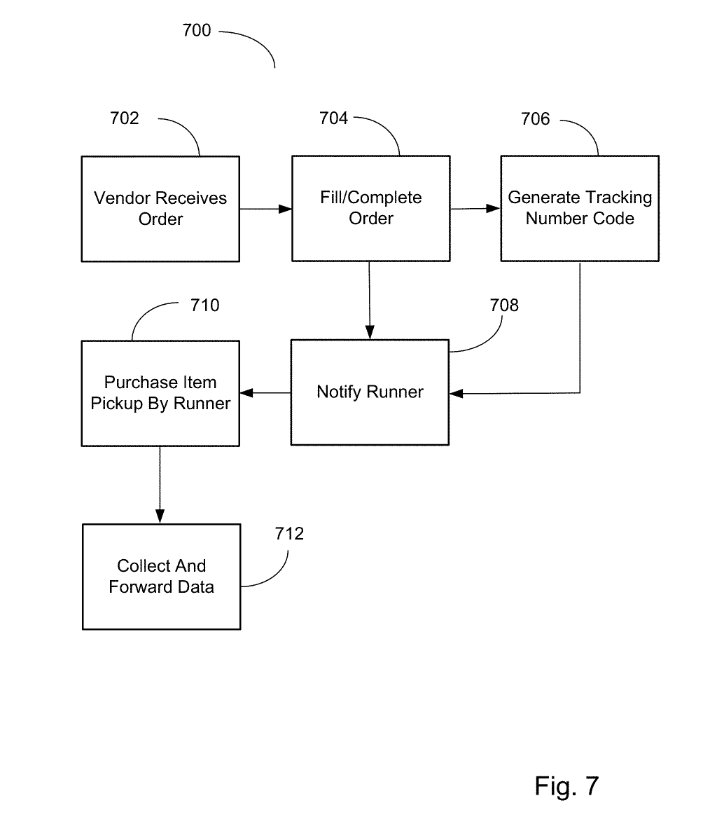

FIG. 7 is a flow chart illustrating the methodology for payment process and ordering of products and services.

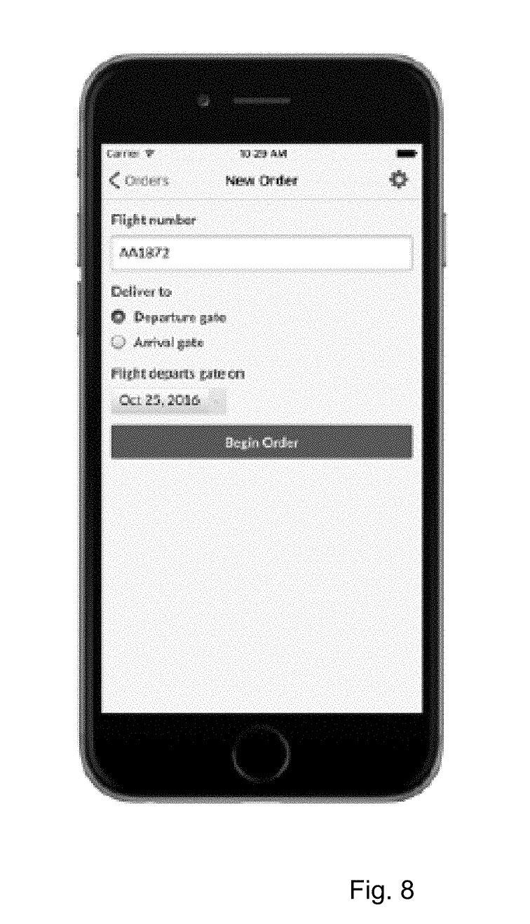

FIG. 8 is a screen shot of a mobile device illustrating the selection of the customer's flight information by the customer.

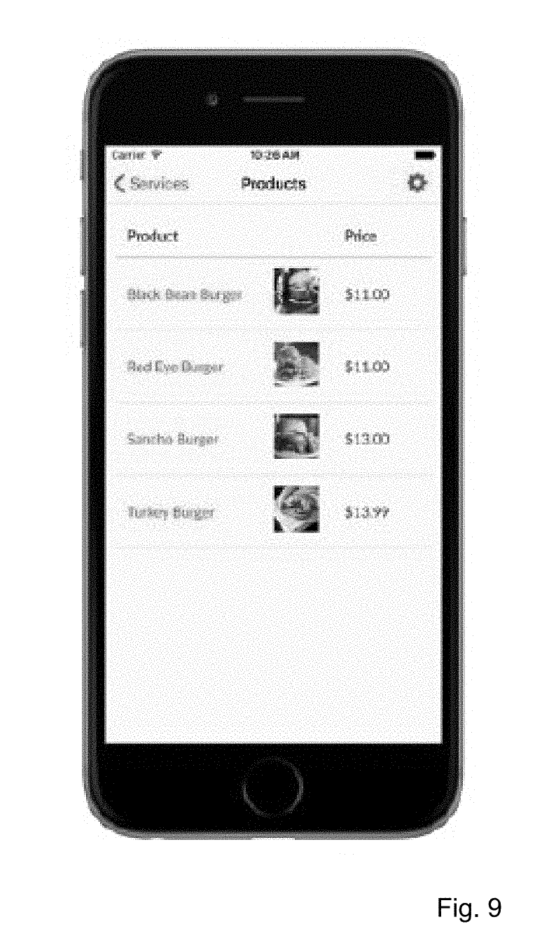

FIG. 9 is a screen shot of a mobile device illustrating the customer selecting a food product.

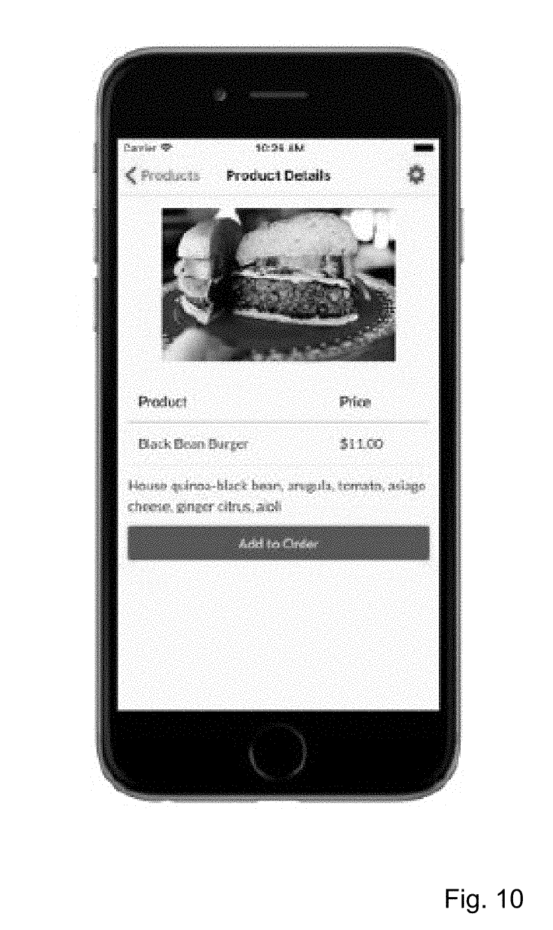

FIG. 10 is screen shot of a mobile device illustrating the customer customizing their order by the addition or deletion of certain toppings on the customer's hamburger.

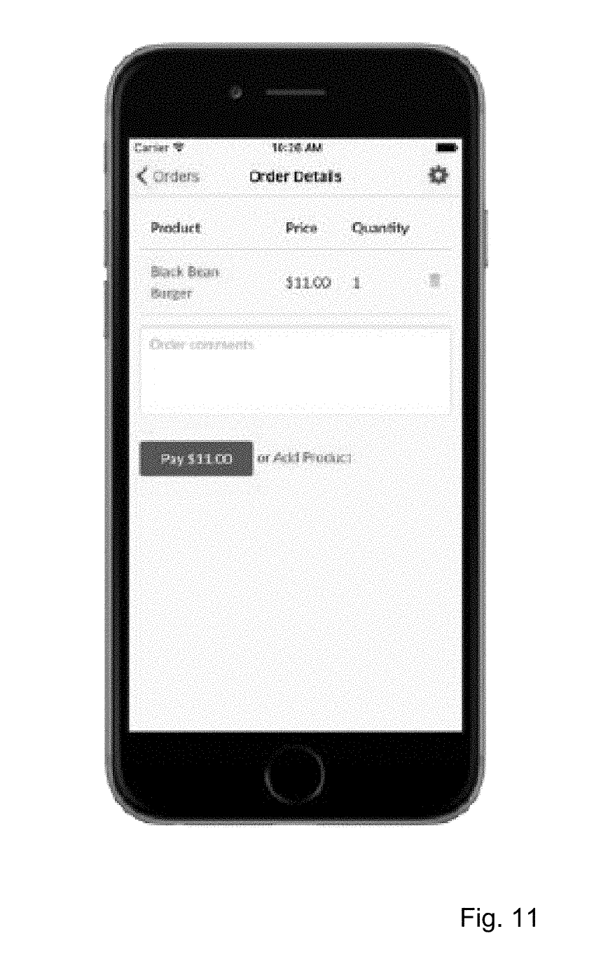

FIG. 11 is a screen shot of a mobile device illustrating the pricing of the customer's order.

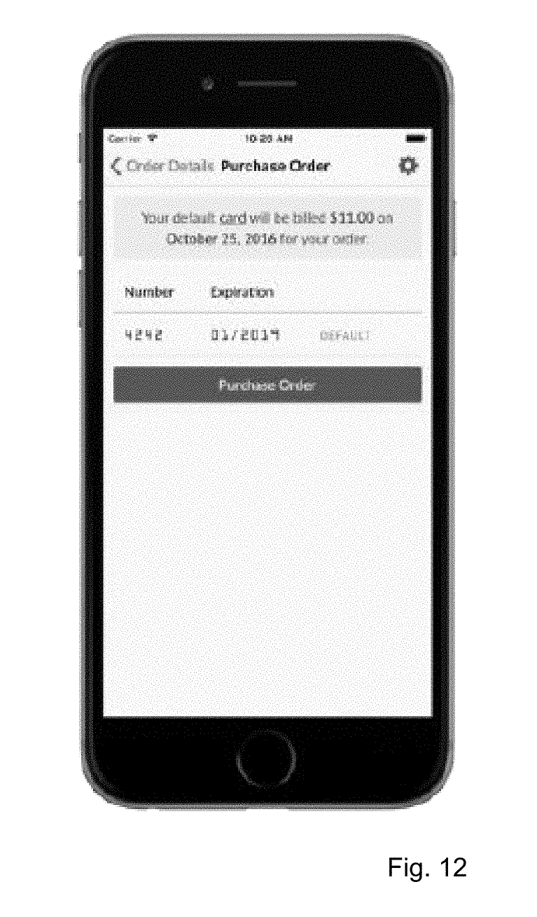

FIG. 12 is a screen shot of a mobile device illustrating the payment of the customer's order by a preloaded credit card in the payment system.

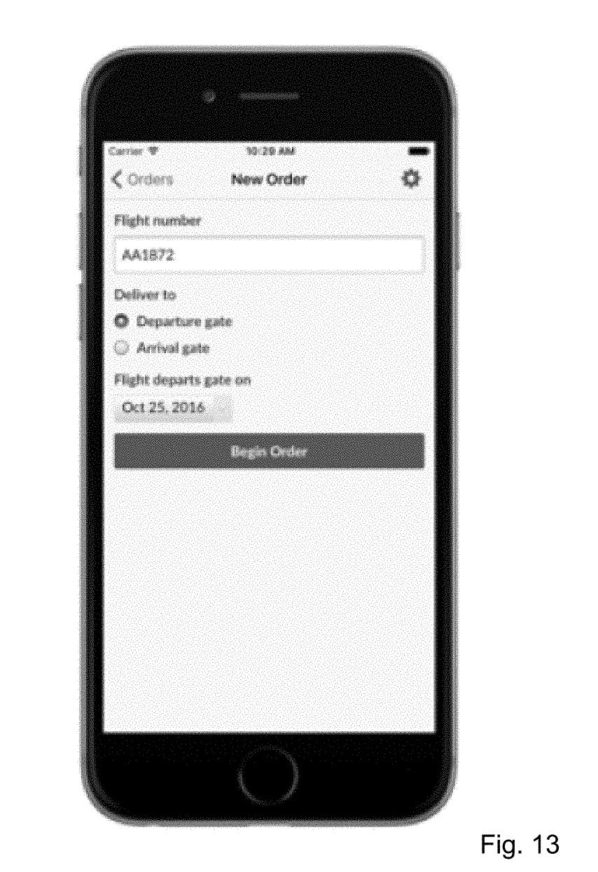

FIG. 13 is a screen shot on a mobile device illustrating the selection of the customer's flight information by the customer.

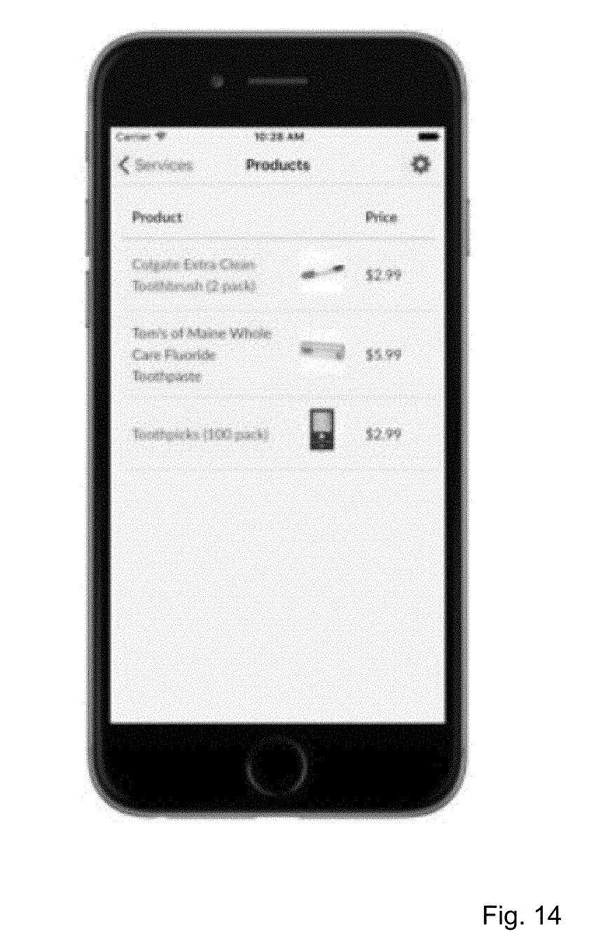

FIG. 14 is a screen shot on a mobile device illustrating the customer selecting a merchandise product.

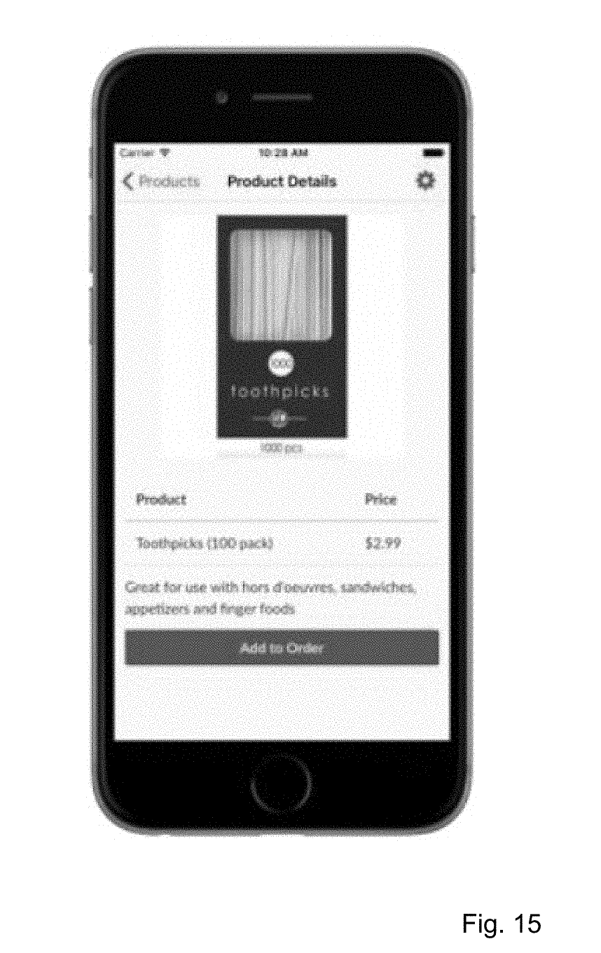

FIG. 15 is screen shot on a mobile device illustrating the customer selecting their desired product and the cost of the selected product.

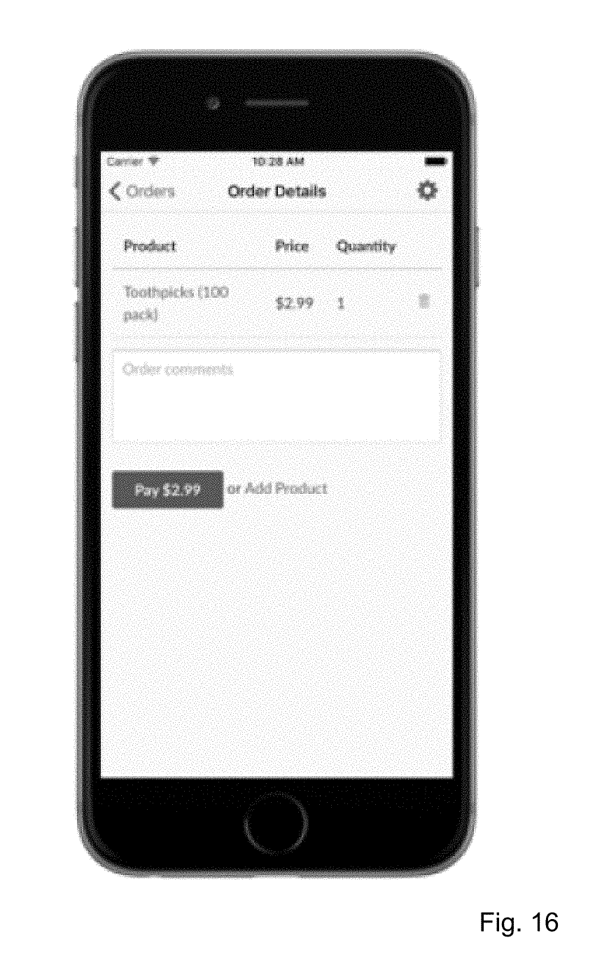

FIG. 16 is a screen shot on a mobile device illustrating payment system inquiring as to whether the customer desires to add to their order and keep shopping.

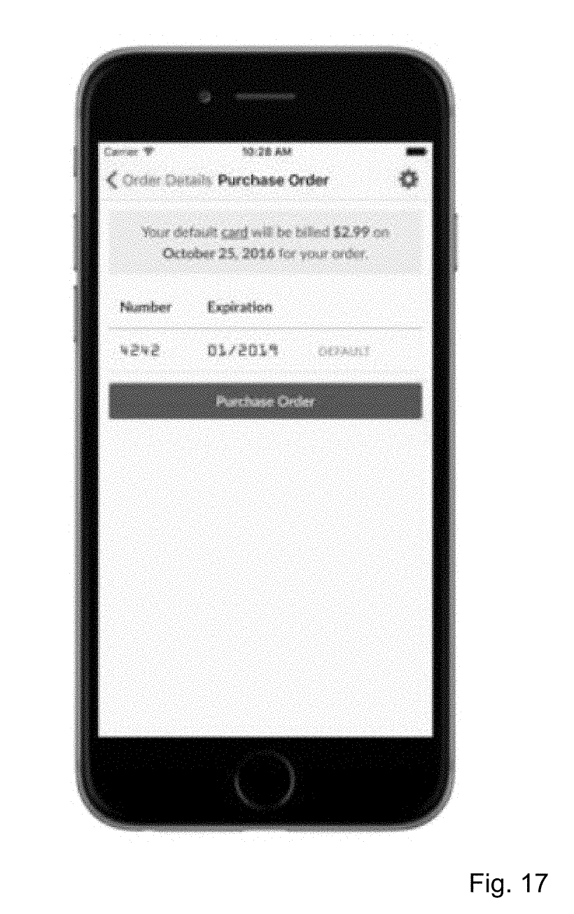

FIG. 17 is a screen shot on a mobile device illustrating the payment of the customer's order by a preloaded credit card in the payment system.

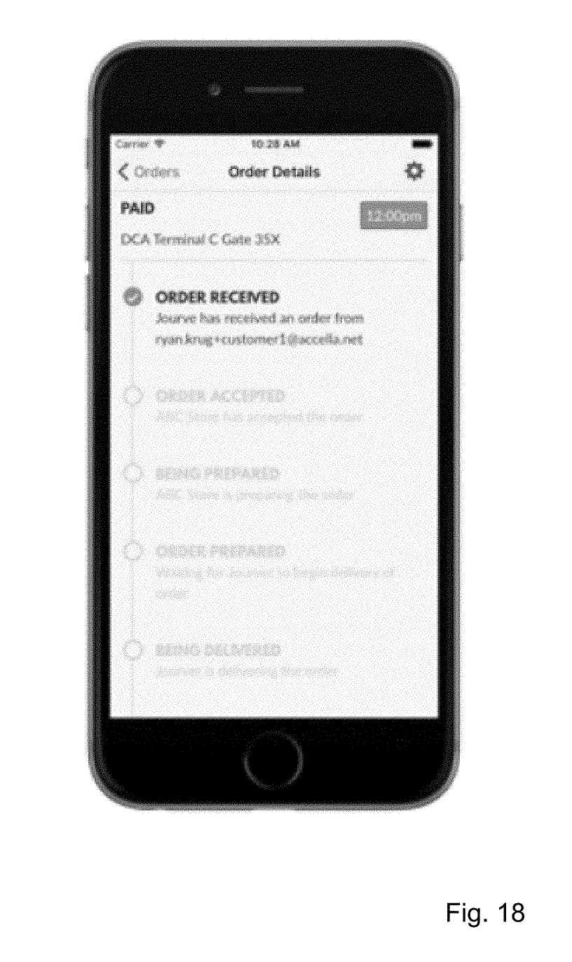

FIG. 18 is a screen shot on the mobile device of the payment system sending a confirmation that the order was received by the customer.

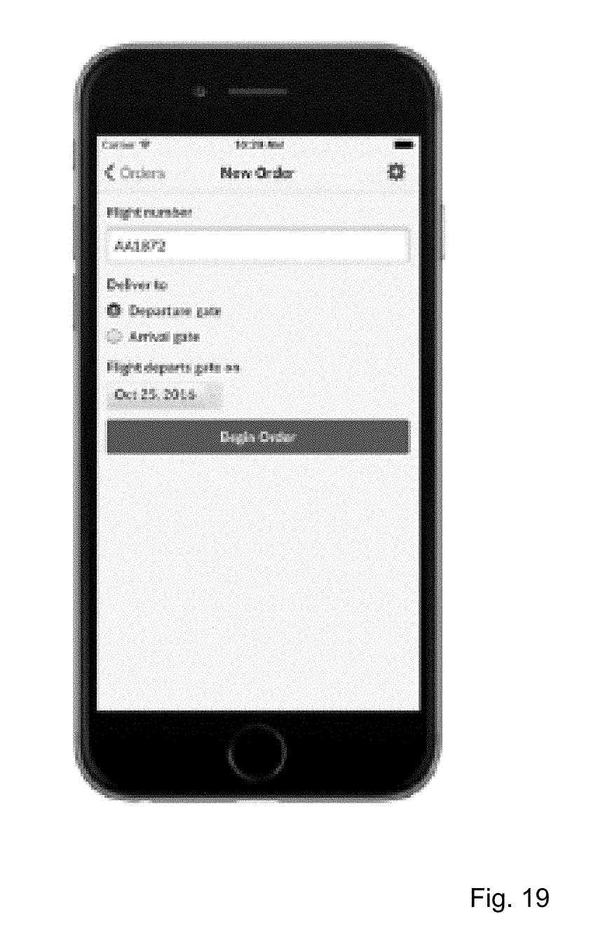

FIG. 19 is a screen shot on a mobile device illustrating the selection of the customer's flight information by the customer.

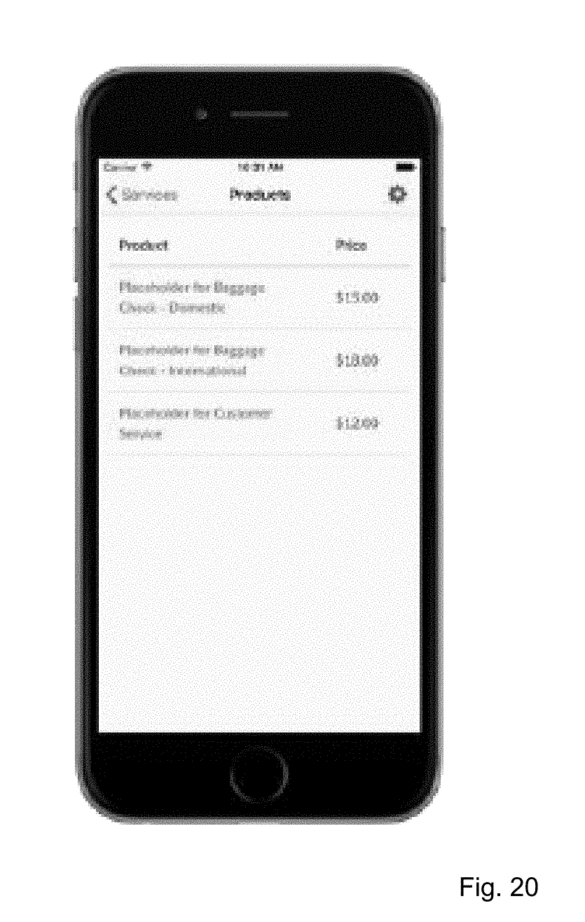

FIG. 20 is a screen shot on a mobile device illustrating the customer selecting a service such as a baggage check.

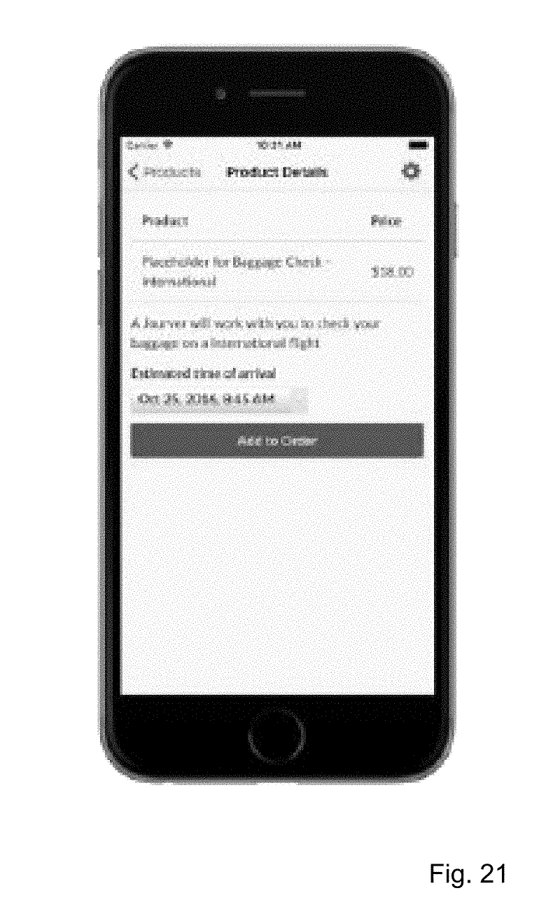

FIG. 21 is screen shot on a mobile device illustrating the customer selecting their desired service and the cost of the selected service.

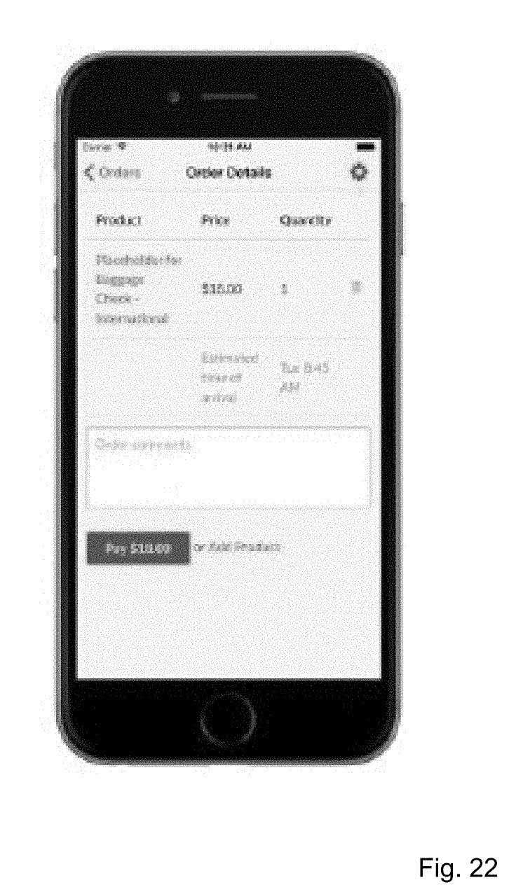

FIG. 22 is a screen shot on a mobile device illustrating payment system inquiring as to whether the customer desires to add to their order and keep shopping for additional services.

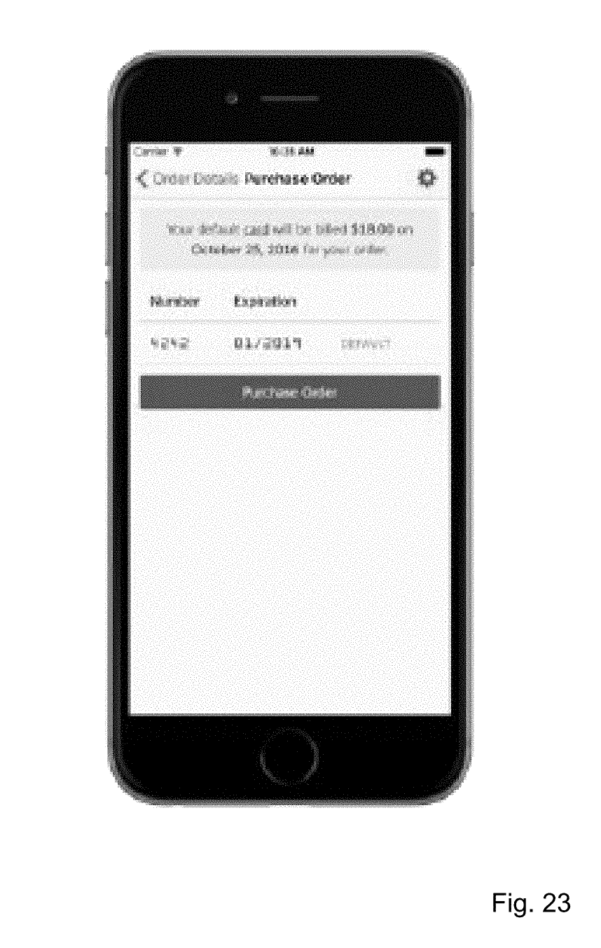

FIG. 23 is a screen shot on a mobile device illustrating the payment of the customer's order by a preloaded credit card in the payment system.

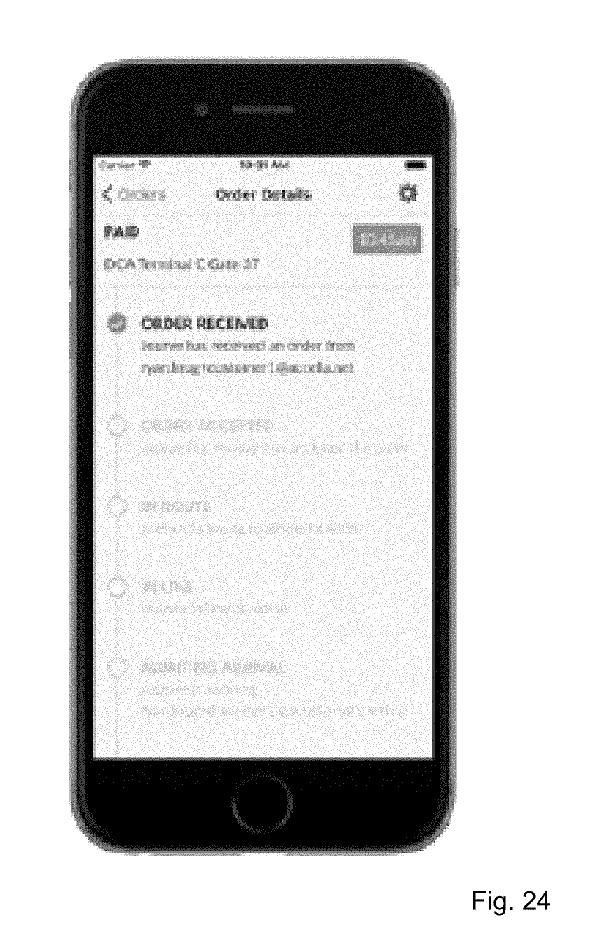

FIG. 24 is a screen shot on the mobile device of the payment system sending a confirmation that the order for services was received by the customer.

### DETAILED DESCRIPTION

This invention can facilitate the purchase and delivery of products that are sold by vendors at airports or other described venues. Examples of airport vendors include restaurants, retail stores (e.g. bookstores, gift stores, etc.), and traveler services (e.g. renting out bedding or traveler care packages that could include a cot, blanket, pillow, etc. that would be useful in flight delays requiring an overnight stay in the airport). In one embodiment, this invention can be implemented by an electronic commerce provider that serves people who are traveling through airports. In this embodiment, the methodology for delivering a product to a customer is performed electronically. From the customer's perspective, the electronic commerce provider receives the identification of a designated airport. The designated airport may be established as the customer's arrival or departure airport. The customer is provided with a selection of products that are available at the designated airport. In some instances, the customer may be provided with a selection of vendors that sell the available products.

From this selection of products, the customer can submit an order via a mobile device software application or by accessing a website on the Internet to access the electronic commerce provider. The customer order comprises at least one selected product and optionally, a selected vendor as well as the customer's flight information. In some instances, the flight information may include one or more of gate number, gate location, flight number, airline name, expected arrival time, expected arrival date, expected departure time, or expected departure date.

The customer order is next received by the electronic commerce provider. From the information in the customer order, the electronic commerce provider determines a vendor order that will be submitted to a vendor at the designated airport. The vendor order comprises the selected product and the delivery time (and optionally, the date) that the product should be ready for delivery to the customer. This delivery time can be determined from the customer's flight information in any suitable way, such as using the flight time indicated by the customer, looking up the flight information from the flight number provided by the customer. The time can also be adjusted according to the customer's indicated preference. For example, a particular customer may want the product delivered thirty (30) or fifteen (15) minutes prior to the customer's departure time. The electronic commerce provider may monitor the customer's flight information to make any changes to the time adjusting for delays in departure or arrival times.

The electronic commerce provider transmits the vendor order to a vendor at the designated airport. The vendor can be one that is selected by the customer. Using the flight information provided by the customer, the electronic commerce provider determines the proper delivery destination within the designated airport. The delivery destination can be a particular gate in the airport, a particular wing of the airport, a particular airline section of the airport, a particular baggage claim area, or the like. In some cases, the electronic commerce provider transmits a message to the customer (e.g. via email, text message, etc.) that the delivery order has arrived at the delivery destination or is on its way. The product is then delivered to the customer at the delivery destination before the customer's flight departure time or after the customer's flight arrival time.

In another embodiment, the methodology can be performed by someone who is traveling through an airport. In this embodiment, the methodology can include the traveling making an advance purchase from an airport vendor. This advance purchase is facilitated by an electronic commerce provider that interacts with the traveler (e.g. via a mobile device application or on a website). The traveler or customer can designate the desired airport to which they are traveling, which can be a departure airport or an arrival airport. The customer receives from the electronic commerce provider, a selection of products that are available at the designated airport. In some instances, the customer also receives a selection of vendors that sell the available products.

The customer submits an order to the electronic commerce provider. The customer order comprises a selected product and the customer's flight information (e.g. flight number, flight time, etc.). At the designated arrival or departure airport, the selected product will be made available to the customer at a pre-determined delivery destination within the airport (e.g. at the arrival or departure gate, at a particular baggage claim area, etc.). In some cases, the customer receives a message (e.g. via email, text message, etc.) that the delivery order has arrived at the pre-determined delivery destination or is on its way. The customer receives the selected product at the pre-determined delivery destination before the customer's flight departure time or after the customer's flight arrival time.

In another embodiment, this invention is a computer system comprising one or more computers that are programmed to perform the steps described above. The interactions or communications between the customers, the electronic commerce provider, and the vendors (e.g. receiving orders, submitting orders, transmitting messages, etc.) can be conducted electronically over any conventional communication network, such as the Internet, using any conventional communication protocol. The software platform for implementing this invention can vary depending on design considerations such as customer preference, cost, implementation, ease of use, machine capabilities, network limitations, etc. For example, the product selection and ordering may be executed by a software application on the customer's mobile device or by a website operated by the electronic commerce provider. The hardware platforms used by the electronic commerce provider, the customers, and the vendors may be different, but operate together as a system.

FIG. 1 illustrates an exemplary system 100 consistent with the disclosed embodiments. As shown in FIG. 1, the system may include a center unit 102, a vendor unit 104, a runner unit 106, and a customer unit 108. The center unit 102 allows a vender, a customer, and/or a runner to download certain program into their computer, tablet, smart phone, or any other device with an appropriate computing system.

The vendor unit 104 may be further categorized as a retailer unit and a restaurant unit. The retailer unit allows the retailer to enter inventory for sale in the system 100, to set and change item pricing, to monitor inventory, and to view the total sales per site per location. In certain embodiments for the system 100 used for air traveler, the location may be an airport. The restaurant unit allows the restaurant to enter menu in the system 100, to set and change item pricing, to monitor inventory, and to view the total sales per site per location. In certain embodiments for the system 100 used for air traveler, the location may be an airport.

The various units, e.g., the center unit 102, the runner unit 106, the customer unit 108, and the vendor unit 104, may be implemented using any appropriate computing systems. Different units may be located on a single device. Different units may also be located on different devices.

The center unit 102, the runner unit 106, the customer unit 108, and the retailer or restaurant unit 104 may use different computing system 200. These units may also share a computing system 200. The units may use computing systems 200 in various combinations. For example, the center unit 102 and the runner unit 106 may share a computing system 200, the vendor unit such as retailer or restaurant 104 may use an individual computing system 200, and the customer unit 108 may use an individual computer system 200. Any appropriate combinations of using computing system may be used.

FIG. 2 is a block diagram of an example implementation of the purchasing system within a computing device. In this example, the computing device includes one or more processors 200, one or more memories 202, a computer-readable medium 204, and one or more communications interfaces 206. In this example, the one or more processing units 200, one or more memory units 202, computer-readable medium 204, and one or more communication interfaces 206 are in signal communication and operatively connected with each other via a bus signal path 208 which may include one or more system buses such as a data bus, an address bus, a PCI bus, a Mini-PCI bus, and any variety of local, peripheral, and/or independent buses.

The computer-readable medium 204 includes encoded computer-executable instructions that cause the one or more processors 200 to generate a data store 210 from the collected data 212 from the sensors and user input thus generating control output signals based on the collected data 212 and optional environmental data.

As utilized, the one or more processing units 200 may represent, for example, a CPU-type processing unit, a GPU-type processing unit, a field-programmable gate array (“FPGA”), digital signal processor(s) (“DSP”), or other hardware logic components that may, in some instances, be driven by a central processing unit (“CPU”). For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

The computer-readable medium 204 may store instructions executable by the one or more processing units 200. The computer-readable medium 204 may also store instructions executable by external processing units (not shown) such as by an external CPU, an external GPU, and/or executable by an external accelerator, such as an FPGA type accelerator, a DSP type accelerator, or any other internal or external accelerator. In various embodiments, at least one CPU, GPU, and/or accelerator is incorporated in the computing device, while in other embodiments, one or more of a CPU, GPU, and/or accelerator may be external to the computing device.

The computer-readable medium 204 may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media may include tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to the computer storage medium 210, communication media may embody computer-readable instructions, data structures, program modules, or other data in a modulated data signal, such as a carrier wave, or other transmission mechanism.

The one or more communication interfaces 206 may represent, for example, network interface controllers (“NICs”) or other types of transceiver devices to send and receive communications over a network. In this example, the computer-readable medium 204 includes a data store 210. In some examples, the data store 210 may include data storage such as a database, data warehouse, or other type of structured or unstructured data storage for operation of computing device and the purchasing system. In some embodiments, the data store 210 may include a corpus and/or a relational database with one or more tables, indices, stored procedures, and so forth to enable data access of the purchasing system by a user including, for example, one or more of hypertext markup language (“HTML”) tables, resource description framework (“RDF”) tables, web ontology language (“OWL”) tables, and/or extensible markup language (“XML”) tables or other means for storing data.

The data store 210 may store data for the operation of processes, applications, components, and/or modules stored in computer-readable medium 204, such as the purchasing system and/or executed by the one or more processing units 200 and/or accelerator(s). As an example, the data store 210 may store environmental data 214, session data 216 and/or other collected data 212. The session data 216 may include data relating to the training sessions performed by the purchasing system. Other examples of session data 216 include, but are not limited to, operational characteristics of the purchasing system for the previous pre-determined amount of time (e.g., hours of operation or days of operation, etc.).

Alternately, some or all of the above-referenced data may be stored on the separate one or more memory units 202 on board the one or more processing units 200 such as, for example, a memory on board a CPU-type processor, a GPU-type processor, an FPGA-type accelerator, a DSP-type accelerator, and/or another accelerator. In this example, the computer-readable medium 204 also includes an operating system 218 and application programming interfaces (“APIs”) 220 configured to expose the functionality and the data generated by the operation of the purchasing system to external devices associated with the computing device via the one or more communication interfaces 208.

Additionally the computer-readable medium 204 may include one or more modules such as the server module 222, input module (not shown), and output module 224, although the number of illustrated modules is just an example, and the number may vary higher or lower. The server module 222 can act as a longer term storage medium for data collected by the purchasing system. A wireless interface can connect the purchasing system to a cloud based server system where operational, session and environmental data is stored. In another embodiment, a wired interface can connect with the mobile device during battery recharging such that the data stored in memory on the mobile device is periodically uploaded and backed up to a cloud based server system.

That is, the functionality described in this disclosure in association with the illustrated modules in the computing device may be performed by a fewer number of modules or a larger number of modules on one device or spread across multiple devices. In this example, the output module 224 may be in signal communication with one or more output devices such as, for example, one or more displays, sound generating loud speakers or a mobile devices that allow the mobile devices to transmit data to the purchasing system. Similarly, the input module may be in signal communication with one or more input devices such as, for example, a virtual or actual keyboard, mouse or joy stick controller, general pointing device, or a touch screen that accepts input commands from the customer's mobile device to respond to and input commands to the computing device.

FIGS. 3 through 6 illustrate an example food or purchase item purchasing process 300 consistent with the disclosed embodiments. As shown in FIG. 3, the purchasing system first determines whether a customer is a member or not 302. For a non-member, the system 300 queries whether the customer would join as member or would proceed as a one-time purchaser 306. For customer who wishes to become a member, the system 300 may proceed to join the customer 308. The customer may input the customer information, such as demographic information, username, password, payment information, and other information that may be used for purchasing purpose. A customer may choose to join anytime and anywhere. For example, the customer may join at home on a computer. A customer may also join right before making purchase using a cell phone or other mobile device. The system 300 may allow any appropriate manners of joining. If the customer is already a member, the customer can just log in 310.

For a member customer to use the system 300, the customer may simply log in to the system 310 and proceed to next step. After log in, the member may choose to view his or her information, or edit information, or proceed to purchase. As a member, the customer may enjoy certain benefit compared to one-time user. For example, the member may have payment information stored so he or she may save time for not having to input the payment information. The system 300 may analyze the member's preference on food or purchase item and recommend certain vendors. The system 300 may offer member discount for purchase.

A person may access the system 300 anytime, anywhere and using any appropriate device. For example, a person may access the system a day before the intended purchase at home using a computer. In another example, a person may access the system 300 a few hours before the intended purchase at a location not far away from the intended location for purchase using a smart phone. In another example, a person may access system 300 while on a flight to an airport hours or minutes before the intended purchase. Connector A 312 connects the process flow chart of FIG. 3 with the process flow chart of FIG. 4.

In FIG. 4, the customer may first enter his or her information (310). In certain embodiments, the payment system 300 may be used for air traveler. The traveler may enter the travel information, such as the airline, the date of the flight, flight number, departing airport, and arriving airport. The payment system 300 may also extract the relevant information automatically. For example, the traveler may only need to input the flight number and the date, and the payment system 300 may extract other information such as departing and arriving airport, departing and arriving time, and gate. The payment system 300 may also be used in other situation. For example, a person may use the payment system 300 before for his or her work day meal purchase. In this instance, the person may input the information such as the destination and the time of arrival. If a member used the payment system 300 for multiple times, the payment system 300 may “memorize” the “preference” of the member and suggest to the member the information such as arriving airport. The customer may input the information 400 into the payment system 300 in advance. The payment system 300 may allow the customer to change the information 400. For example, the customer may change the flight arriving time.

The customer may then select the area for the food or purchase item to be picked-up 402. In certain embodiments, a customer may use the payment system 300 for air travel and may select the airport for purchase. The payment system 300 may allow the customer to change certain information. For example, the payment system 300 may allow the customer to change the time for pickup. The customer may then select the vendor 404. The payment system 300 may include many vendors in the area. In certain embodiments, the payment system 300 may include the vendors in an airport for the customer to choose or vendors just off the airport location.

The customer may then view the vendors' information 406. For example, the payment system 300 may display information such as the name of the vendor, the business type of the vendor, such as restaurant or a retail store, the category of the vendor, such as Chinese food restaurant or newsstand, sale information, and rating information. The payment system 300 may display any appropriate and/or relevant information for the customer to view. The customer may then select the item for purchase 408 and make the purchase 410. Connector B 412 connects the process flow chart of FIG. 4 with the process flow chart of FIG. 5.

The payment system 300 may then decide whether the customer is a member or not 500. For a non-member, the customer may then enter the payment information 502, such as credit card information. The customer may use a variety of payment method, such as credit card, Paypal, or link to a bank account. Any other appropriate payment method may be used by the customer. For a member customer 504, the customer may choose to enter the payment information or choose a payment method already stored in the payment system 300. In addition to the payment methods available to a non-member, a member may have a deposit account within the payment system 300 for payment purpose. The payment system 300 may conduct a payment calculation 506. In certain embodiments for air traveler, the payment may include food or purchase item cost, tax, airport fee, tip, delivery fee, and any other cost items. Connector C 508 connects the process flow chart of FIG. 5 with the process flow chart of FIG. 6.

The payment system 300 then decides whether the product such as food or a merchandise product is available based on the feedback from the vendor 600. If the food or purchase item is not available at the time of the order and/or the time of the expected delivery, the system 300 may suggest the customer to go back to select item for purchase via Connector D 602 which returns the customer to Connector D 602 in FIG. 4.

If the product such as food or a merchandise product is available 600, the customer may receive order information 604. The order information may be sent in forms of email or text message. The order information may also be sent in any appropriate form or methods. The order information may include the expected delivery time and location. In certain embodiments for payment system 300 used for customers, the order information may include the gate number for delivery. The order information may also include delivery confirmation code. The delivery confirmation code may be a bar code or a Quick Response Code (QR). The delivery confirmation code may use any appropriate method.

The payment system 300 may send the customer delivery information when the food or purchase item is ready at the expected delivery location 606. The delivery information may be sent in forms of email or text message. The delivery information may also be sent in any appropriate form or methods. In certain embodiments for payment system 300 used for customers, the delivery information is sent when the food or purchase item is delivered to the expected gate. The payment system 300 may send other information to the customer, such as the initiation, fill or completion, and pickup by runner of the food or purchase item.

The payment system 300 may receive the delivery confirmation when the product such as food or a merchandise product is delivered 608. The delivery may be confirmed through any appropriate methods. For example, the delivery may be confirmed by scanning the bar code or QR code. The payment system 300 may send customer rating information for the customer to rate the vendor and/or the delivery person 610. Delivery person may be referred to as runner.

For a customer to use the payment system 300, the customer pays a fee to the owner and/or operator of the payment system 300. The fee may be a percentage of the price of the food or purchase item purchased. The fee may be a one-time fee. The fee may also be a membership monthly fee. The fee arrangement may be in any appropriate means.

FIG. 7 is a flow chart illustrating the receipt by the vendor of an order. In FIG. 7, the payment system 700 may send order information to a vendor 702, such as retailer or restaurant, or any other types of vendors. The vendor may fill or complete the order 704. The vendor can create a tracking number code to the order 706 as an optional step. The payment system 700 may allow the vendor to send notification of completed order to runner 708. The tracking number code 706 may be the same as the delivery confirmation code. The tracking number code 706 may also be different to the delivery confirmation code. The tracking number code may be a bar code or a Quick Response (“QR”) Code. The tracking number code 706 may use any appropriate method. The payment system 700 may record and collect the tracking number code and its associated information, such as the corresponding food or purchase item, the price, delivery specifics, and any other information.

The runner may pick up the food or purchase item 710. The payment system 700 collects the pickup information through tracking the tracking number code. The payment system 700 may collect the pickup information through any appropriate methods, such as scanning the tracking number code. The payment system 700 may collect all purchase information for a particular vendor on a daily basis and the information may be provided to the vendor 712.

For a vendor to use the payment system 700, the vendor becomes a participating provider. The participating provider pays a fee to the owner and/or operator of the payment system 700. The fee may be a percentage of the sales revenue. The fee may also be a membership monthly fee. The fee arrangement may be by any appropriate means well known to one skilled in the art.

A runner may be a person working with the owner and/or operator of the payment system 700. A runner may be a person who chooses to participate in the operation of the payment system 700. For example, a runner may be a traveler with substantial time at an airport waiting for transfer and may utilize the time to deliver food or purchase item on demand and make extra income. The runner may be connected to the runner unit 106 using any device, such as smart phone, through any connection method, such as wireless internet.

A runner may receive notification from the payment system 700 of the purchase item's availability for delivery from the participating vendors. The runner may pick up the purchase item and scan the item. The runner may then deliver the purchase item to the customer at designated location. Upon the delivery, the delivery may be confirmed by any appropriate methods, such as scanning the delivery confirmation code and/or the tracking number code.

The payment system 700 may perform other tasks. For example, the payment system 700 may mange traveler experience, may track flight information for a traveler, may manage inventory of participating vendors, may manage credit card and payment information of customers, may track and manage orders from order initiation to order delivery, may send customers with receipt, completion, delivery status including delays of order delivery, may manage payment and accounting of orders for individual vendors for each all daily purchases, and may track and schedule runners.

Some of the unique features of the software application is the synchronization of the customer's flight information with the customer's services. The services can be managed by connecting the services with the customer's flight information such as the customer's airline and flight number. Some of these features are:
1. For food and retail pick-up and delivery, via the flight number, the application is able to determine the arrival and departing gate of the customer's flight and from pre-set vendor information determine the preparation time, amount of time needed for pick up and or delivery.
2. For Valet Services, via flight number, the software application is able to determine airline and departing and arrival curbside location.
3. For Position Reservation, via flight number, the application is able to determine airline and departing gate.
4. Priority Security Line Access, via flight number, the application is able to determine airline and departing security gate.

Due to the variety of potential Point of Sale (“POS”) systems, the current version of the application is designed to be utilized by restauranteurs and retail establishment with Wi-Fi enabled tablets such as iPads. These tablets could be provided by vendor with participation in the software application. The tablets would serve as the portal for the administrative website for the software application and main site for vendor access and services for the software application.

Service Delivery Workforce

All of the concierge services provided by a payment system operator could will be comprised of the shared economy workforce. These independent contractors will include pre and post security independent contractors, current airport staff who are available for additional work hours during their non-scheduled hours with current airport employers and airport travelers on extended layovers. As any customer with a mobile device can be a customer, any previously screened individual.

Utilizing the shared workforce economy such as independent contractors to provide delivery of food and retail purchases and perform concierge services, will assist travelers in navigating the flow of the necessary airport services while ultimately improving their traveling experience. The mobile application can link retailers/restaurateurs, concierge services and delivery personnel to the customer such as airline travelers. The advantages of the shared workforce economy will allow for exercise of the peer-to-peer market. These advantages include the creation of new services, workplace flexibility and a reimbursement model that can be just as or more lucrative than full-time jobs.

Customer Mobile Application.

Customers will access the payment system 300 through the customer mobile software application. Through this software application, customers can access the following services:

Food Delivery.

Order Entry and Payment

Customers are able to access any airport participating restauranteur via the application. Through the use of the customer flight number and date of travel, will access available restaurants by Service/Food or Vendor Name. Upon accessing the selected restaurant, the customer is able to purchase all items listed by the restaurant and they can be prepared, picked up or delivered in compliance with the restaurant's pre-set prep times and predetermined delivery times. Upon selection of the food, comments can be entered for further requests about the items ordered. If customer's order cannot be prepared within the restauranteur's predetermined preparation time for the flight, the customer will receive notification that the item selected is not available for customer's flight departure time. Upon submission of the order, the customer receives an email confirmation of the order being received and tracking of the order begins via email and through the order details of the software application.

Upon selection of the order, the customer pays with a valid credit card that is entered into the software application. Upon acceptance of the order by the restauranteur, the customer's credit card is billed. In one transaction the customer's payment is divided as follows: (1) payment is sent to the restauranteur's pre-determined bank account, (2) payment is sent to a pre-determined bank account and (3) payment of fees are remitted to its pre-determined bank account.

Order Acceptance, Preparation and Delivery

Restaurateur acceptance is required for progression of the order and charging of the customer's credit card. If the order is declined by the restaurateur the order is declined and the customer's credit card is not charged. Upon order acceptance, the predetermined preparation time for the order is sent to the accepting the delivery person so that the order can be picked up at the time of delivery. Upon completion of the preparation of the order, vendor who has accepted the order will begin delivery and complete delivery of the food item to the customer's selected arrival or departing gate. The software application, any airport location can be input and selected for delivery, such as lounges and other airport locations.

Communications.

Throughout the order, preparation and delivery process, the customer is receiving email or text updates of the order progress and the progress can be followed within the software application in order details. Additionally, the customer the vendor is able to communicate via text, email or phone call and the customer is able to communicate to the vendor via phone call. Moreover, customers are able to email the payment system provider directly for customer service concerns.

FIGS. 8 through 12 are screen shots of the software application in operation on a mobile device. FIG. 8 is a screen shot on a mobile device illustrating the selection of the customer's flight information by the customer. FIG. 9 is a screen shot on a mobile device illustrating the customer selecting a food product. FIG. 10 is screen shot on a mobile device illustrating the customer customizing their order by the addition or deletion of certain toppings on the customer's hamburger. FIG. 11 is a screen shot on a mobile device illustrating the pricing of the customer's order. FIG. 12 is a screen shot on a mobile device illustrating the payment of the customer's order by a preloaded credit card in the payment system.

Retail Delivery

Order Entry and Payment

Customers are able to access any airport participating retailer via the application. Through the use of the customer flight number and date of travel, the customer will access available retailers by Service/Retail or Vendor Name. Upon accessing the selected retailer, the customer is able to purchase all items listed by the retailer and they can be packaged, picked up or delivered in compliance with the retailer's pre-set prep times and predetermined delivery times. Upon selection of the retail item, comments can be entered for further requests about the item ordered. If customer's order cannot be packaged within the retailer's predetermined preparation time for the flight, the customer will receive notification that the item selected is not available for customer's flight departure time. Upon submission of the order, the customer receives an email confirmation of the order being received and tracking of the order begins via email and through the order details of the software application.

Order Acceptance, Preparation and Delivery.

Retailer acceptance is required for progression of the order and charging of the customer's credit card. If the order is declined by the retailer the order is declined and the customer's credit card is not charged. Upon order acceptance, the predetermined packaging time for the order is sent to the accepting delivery person so the order can be picked up at the time of delivery. Upon completion of the packaging of the order, runner who has accepted the order will begin delivery and complete delivery of the retail item to the customer's selected arrival or departing gate. Any location can be input and selected for delivery such as lounges and other airport locations.

Communications.

Throughout the order, packaging and delivery process, the customer is receiving text, voice call or email updates of the order progress and the progress can be followed within the software application in order details. Additionally, the customer and runner are able to communicate via text, email or phone call and the customer is able to communicate to the retailer via phone. Additionally, customers are able to email the runner or payment system customer support for customer service concerns.

FIGS. 13 through 18 are screen shots on a customer's mobile device illustrating the customer service process. FIG. 13 is a screen shot on a mobile device illustrating the selection of the customer's flight information by the customer. FIG. 14 is a screen shot on a mobile device illustrating the customer selecting a merchandise product. FIG. 15 is screen shot on a mobile device illustrating the customer selecting their desired product and the cost of the selected product. FIG. 16 is a screen shot on a mobile device illustrating payment system inquiring as to whether the customer desires to add to their order and keep shopping. FIG. 17 is a screen shot on a mobile device illustrating the payment of the customer's order by a preloaded credit card in the payment system. FIG. 18 is a screen shot on the mobile device of the payment system sending a confirmation that the order was received by the customer.

Airport Process Services.

Additional services may be used to assist the traveler with processes and expedite movement through the airport to the traveler's destination. These services can include line position reservations, priority security line access, valet services, rental car return, personal car parking and return, navigating airline customer service lines that include baggage check-in lines, boarding pass retrieval lines, international airline service lines and TSA security lines.

Experiencing any of these necessary travel processes can make the airline travel experience unpredictable. Through the utilization of the payment system customers will be able to request reservations as to their place in line at any of the above service processes.

Through input of the customer flight number, date of travel and estimated time of arrival, the customer is able to request a reservation in a vendor's line position. Upon order initiation by the customer, the payment system accepts the order and a runner proceeds to the location of line reservation request. The in-route, in line and awaiting customer arrival tracking begins by the runner and is confirmed via email and can be tracked through the order details of the software application. The customer is billed in 30 minute intervals until their arrival at the identified location and the traveler assumes their place in line.

FIGS. 19 through 24 are screen shots on a customer's mobile device illustrating the customer service process. FIG. 19 is a screen shot on a mobile device illustrating the selection of the customer's flight information by the customer. FIG. 20 is a screen shot on a mobile device illustrating the customer selecting a service such as a baggage check. FIG. 21 is screen shot on a mobile device illustrating the customer selecting their desired service and the cost of the selected service. FIG. 22 is a screen shot on a mobile device illustrating payment system inquiring as to whether the customer desires to add to their order and keep shopping for additional services. FIG. 23 is a screen shot on a mobile device illustrating the payment of the customer's order by a preloaded credit card in the payment system. FIG. 24 is a screen shot on the mobile device of the payment system sending a confirmation that the order for services was received by the customer.

Priority Security Line Access.

The payment system can offer on-demand access to priority security line. The software application will serve as the source for passengers to upgrade to priority (“fastpass”) security line services. Through input of the customer flight number, date of travel and estimated time of arrival, the customer is able to procure priority security line access. The cost and amount of service is to be determined in coordination with the participating airport.

Valet Services.

The payment system can offer the airport traveler a variety of valet services. These services will include rental car return with optional gas re-fill and personal car valet parking. Through the mobile software application, the customer can procure valet services from the traveler's airline departure/arrival curbside location.

Rental Car Return

Through input of the customer flight number, make, model, year, rental car company, date of travel and estimated time of arrival, the customer is able to procure a runner to meet the customer at their airline's departure curbside location. Upon order initiation by the customer, a runner accepts the order, the customer's credit card is billed and the runner proceeds to the curbside location. The in-route and awaiting customer arrival tracking begins by the runner and is confirmed via email and can be tracked through the order details of the software application. Upon customer arrival, receipt of vehicle is entered into the app by the runner and return is initiated. Add on services will include gas refill prior to return to rental car facility. The customer receives an email confirmation of the rental car return upon completion by the runner.

Personal Car Valet.

The personal car valet service will be offered for departure and arrival of the customer. Thus customer s will procure a runner to valet their vehicle from airline curbside upon departure and a runner will be awaiting the same returning customer upon arrival at the airline curbside arrival location. Through input of the customer departing flight number and date and returning flight number and date, make, model, year of the vehicle, and estimated time of arrival, the customer is able to procure a runner to meet the customer at their departure and subsequent arrival. Upon order initiation by the customer, a runner accepts the order and the customer's credit card is billed for the valet services and the runner proceeds to the curbside location. The in-route and awaiting customer arrival tracking begins by the runner and is confirmed via email and can be tracked through the order details of the software application.

Upon customer arrival, receipt of the vehicle is entered into the app by the runner and parking to the contracted parking facility is initiated. Via tracking of the customer's return flight, the software application assigns a runner to retrieve the vehicle from the parking facility and await the arrival of the customer at their arrival airline curbside location. The customer's credit card is then charged for the cost of the parking. Upon the customer's return, vehicle is returned to the customer. The customer receives an email confirmation of the return. All valeted vehicle keys will be kept in a secure location.

Customer Pick Up.

Customer pick-up can function the same as food delivery. At the time of order, the customer will designate whether their item is for pick-up or delivery.

While various embodiments of the invention have been described, it will be apparent to those of ordinary skill in the art that many more embodiments and implementations are possible that are within the scope of this invention.

What is claimed is:

1. A method of delivering a product to a customer by electronic commerce, comprising:
receiving from a customer via a device, an identification of a designated venue for making a delivery to the customer;
transmitting to the customer's device, a selection of products that are available for sale at the designated venue;
receiving from the customer's device, a customer order that comprises a selected product, information relating to a delivery time, and a delivery location within the designated venue;
transmitting the customer order to a vendor located at the designated venue;
delivering the selected product to the customer at the delivery location within the designated venue according to the information relating to the delivery time.

2. The method of claim 1, where the designated venue is an airport and the information relating to the delivery time is the customer's flight information.

3. The method of claim 2, where the flight information comprises a flight time and a gate or terminal number of the airport, and wherein the delivery location is the airport's gate or terminal number.

4. The method of claim 3, further comprising monitoring the customer's flight information for changes in flight time or gate number.

5. The method of claim 2, where the designated venue is the gate or terminal number at the customer's arrival or departure airport.

6. The method of claim 5, where the delivery time is after the customer's time of arrival or before the customer's time of departure.

7. The method of claim 1, further comprising transmitting a message to the customer's device indicating that the customer order has arrived at the delivery location or is on its way.

8. The method of claim 1, further comprising transmitting to the customer's device, a selection of vendors carrying the products that are available for sale.

9. A non-transitory computer readable medium encoded with instructions that when executed by a computer device cause the computer device to perform operations comprising:
receive from a customer via a device, an identification of a designated venue for making a delivery to the customer;
transmit to the customer's device, a selection of products that are available for sale at the designated venue;
receive from the customer's device, a customer order that comprises a selected product, information relating to a delivery time, and a delivery location within the designated venue; and
transmit the customer order to a vendor located at the designated venue.

10. The non-transitory computer readable medium of claim 9, where the designated venue is an airport and the information relating to the delivery time is the customer's flight information.

11. The non-transitory computer readable medium of claim 10, where the flight information comprises a flight time and a gate number of the airport, and wherein the delivery location is the airport's gate number.

12. The non-transitory computer readable medium of claim 11, further comprising monitoring the customer's flight information for changes in flight time or gate number.

13. The non-transitory computer readable medium of claim 10, where the designated venue is the customer's arrival or departure airport.

14. The non-transitory computer readable medium of claim 13, where the delivery time is after the customer's time of arrival or before the customer's time of departure.

15. The non-transitory computer readable medium of claim 9, further comprising transmitting a message to the customer's device indicating that the customer order has arrived at the delivery location or is on its way.

16. The non-transitory computer readable medium of claim 9, further comprising transmitting to the customer's device, a selection of vendors carrying the products that are available for sale.

17. An electronic commerce system comprising:
a central computer system;
a customer computer device in network communication with the central computer system;
a vendor computer system in network communication with the central computer system;
wherein the central computer system is configured to perform operations comprising:
establish network communication with the customer's computer device;
receive from the customer's device, an identification of a designated venue for making a delivery to the customer;
transmit to the customer's device, a selection of products that are available for sale at the designated venue;
receive from the customer's device, a customer order that comprises a selected product, information relating to a delivery time, and a delivery location within the designated venue; and
transmit the customer order to the vendor computer system located at the designated venue.

18. The system of claim 17, where the designated venue is an airport and the information relating to the delivery time is the customer's flight information.

19. The system of claim 18, where the flight information comprises a flight time and a gate number of the airport, and wherein the delivery location is the airport's gate number.

20. The system of claim 19, further comprising monitoring the customer's flight information for changes in flight time or gate number.
